(19) United States
(12) Patent Application Publication
(10) Pub. No.: US 2009/0210927 A1
(43) Pub. Date: Aug. 20, 2009

(54) AUTHENTICATION APPARATUS, AUTHENTICATED PRINTING SYSTEM, AND AUTHENTICATION METHOD

(75) Inventors: Senichi Mokuya, Shiojiri-shi (JP); Taro Ishige, Matsumoto-shi (JP)

Correspondence Address: SUGHRUE MION, PLLC, 2100 Pennsylvania Avenue, N.W., Washington, DC, 20037, US

(73) Assignee: Seiko Epson Corporation, Tokyo (JP)

(21) Appl. No.: 12/371,299

(22) Filed: Feb. 13, 2009

(30) Foreign Application Priority Data
Feb. 14, 2008 (JP) 2008-032540

(51) Int. Cl. H04L 9/32

(52) U.S. Cl. 726/3; 726/2

(57) ABSTRACT

An authentication apparatus of the invention performs an authentication process based on authentication data input from a device used for data entry. The authentication apparatus receives device identification information for identifying the device and matches the received device identification information against authentication-authorized device identification information representing that the device is authorized to be used for authentication. In the case of failed matching of the received device identification information with the stored authentication-authorized device identification information, the authentication apparatus restricts the authentication process. This arrangement ensures the high security in an authenticated printing system including a printing apparatus connectable with at least one device used for entry of authentication data.

### CROSS-REFERENCE TO RELATED APPLICATION

The present application claims priority from Japanese application P2008-32540A filed on Feb. 14, 2008, the contents of which are hereby incorporated by reference into this application.

### BACKGROUND

1. Field of the Invention

The present invention relates to a device-based authentication technique and an authenticated printing technique for printing with device-based authentication.

2. Description of the Related Art

Implementation of the personal information protection law and tendency of the enhanced internal control increasingly attract attention in management of classified information from companies and organizations. In the case of printing classified information, when a printing apparatus is located away from a terminal currently logged in by a user to give a printout instruction, there is a risk that a printout of the classified information may be leaked to a third person before the user reaches the location of the printing apparatus. An authenticated printing system has been proposed as a countermeasure against this potential problem to suspend a printing operation after the user's printout instruction and allow the printing operation in response to only the user's authentication on the side of the printing apparatus (see, for example, Japanese Patent Laid-Open No. 2005-259012).

One available technique for authentication asks each user to swipe an ID card owned by the user through a device provided for authentication. Another available technique for authentication asks the user to press a selected thumb or finger against a device for fingerprint authentication. The device for authentication may be built in an information output apparatus, such as a printing apparatus. For expansion of the versatility, the device for authentication may be connected to a physical port of the printing apparatus via a general-purpose interface. Known standards applicable for the general-purpose interface include USB (universal serial bus) standard and FireWire standard.

Device spoofing, however, undesirably lowers the security level in such a general-purpose interface sharing physical ports. The presence of this security hole has been found by the inventor of the present application. The problem of this security hole is not characteristic of the printing process but is commonly found in a general process of writing information into information recording media and in a general authentication process, such as conventional login authentication.

### SUMMARY

In order to solve the problem of the prior art explained above, there would be a demand for enhancing the security in a system including a device used for entry of authentication data.

The present invention accomplishes at least part of the demands mentioned above and the other relevant demands by the following configurations applied to the authentication apparatus, the authenticated printing system, the authentication data input apparatus, and the corresponding methods.

According to one aspect, the present invention is directed to an authentication apparatus configured to authenticate a user. The authentication apparatus includes: a device used for data entry; an authentication processor configured to input authentication data from the device and perform an authentication process; a device identification information receiver configured to receive device identification information for identifying the device from the device; a device identification information storage unit configured to store authentication-authorized device identification information representing that the device is authorized to be used for authentication; and a limiter configured to, in the case of failed matching of the received device identification information with the stored authentication-authorized device identification information, restrict the authentication process.

The authentication apparatus according to this aspect of the invention stores in advance the authentication-authorized device identification information representing that the device used for data entry is authorized to be used for authentication of the user. The authentication apparatus receives the device identification information for identifying the device from the device and restricts the authentication process in the case of failed matching of the received device identification information with the stored authentication-authorized device identification information. This arrangement effectively prevents fake authentication of an identity thief who illegally connects an invalid device that is not authorized to be used for authentication with the authentication apparatus and transfers fake authentication data of the identity thief to the authentication apparatus. Any of various techniques may be adopted for restricting the authentication process; for example, prohibiting or restricting the data input from the device, prohibiting the authentication process, or prohibiting output of a result of the authentication process. One technique or a combination of multiple techniques among these options may be selected for restricting the authentication process. A system administrator is often assigned for the authentication apparatus or a printing apparatus equipped with a built-in authentication apparatus. The system administrator may be authenticated by a specific device that is different from a conventional device used by ordinary users. In order to handle such a situation, one preferable technique of restricting the authentication process does not uniformly prohibit the authentication process from a different device but accepts authentication of a specific user having administrative privileges from the different device. The specific user having administrative privileges is readily identifiable, for example, based on a preset identification code included in the authentication data.

In one preferable application of the authentication apparatus according to the above aspect of the invention, the device identification information storage unit has a register configured to receive device identification information of a device connecting with the authentication apparatus at a predetermined timing and store the received device identification information as the authentication-authorized device identification information. The predetermined timing is, for example, the timing of installing the authentication apparatus or the timing of first power activation of the authentication apparatus. Alternatively the predetermined timing may be the timing of a preset explicit operation of the authentication apparatus, for example, power activation with a press of a selected operation button. The authentication apparatus of this application receives the device identification information of the device currently connecting with the authentication apparatus at the predetermined timing and stores the received device identification information as the authentication-authorized device identification information. This arrangement ensures extremely easy registration of the authentication-authorized device.

In one preferable embodiment of the invention, the authentication apparatus further has a setter configured to store specific device identification information of a preset device as the authentication-authorized device identification information into the device identification information storage unit. This arrangement allows the specific device to be registered as the authentication-authorized device even when the specific device is not actually connected with the authentication apparatus.

Another application of the above aspect of the invention relates to specification of the device identification information. For example, the device identification information may be a unique code of uniquely identifying the device. One typical technique of device spoofing replaces an invalid keyboard with a card reader as a valid device for data entry and operates the keyboard to illegally enter information recorded in a card. The use of a unique code provided for each device as the authentication-authorized device identification information effectively prevents or avoids fake authentication by replacement of the valid device with the invalid device. One typical example of the unique code includes a vendor code of identifying a manufacturer of the device and a product code allocated to the device. An IC tag, such as an RFID, may be embedded to allocate the unique code to the device.

In one preferable embodiment of the authentication apparatus of the invention, the device is connectable by a general-purpose bus provided for the authentication apparatus and stores class information representing a class defined on the general-purpose bus as the device identification information.

In the case of general-purpose bus connection of a non-registered device having device identification information that is not stored in the device identification information storage unit but matches with a preset class defined on the general-purpose bus, the authentication apparatus of this embodiment allows authentication from the non-registered device. This arrangement advantageously expands the flexibility of device connection, while preventing device spoofing.

The authentication apparatus of the invention may be connected to a network to be used alone or may be built in a printing apparatus connecting with a network. In the latter application, the printing apparatus is configured to obtain print data from a server connected with the printing apparatus via the network and performs a printing operation of the print data, in response to authentication of the user by the authentication apparatus. This arrangement ensures the high security of authentication for authenticated printing via the network.

The authentication apparatus of the invention having any of the arrangements discussed above restricts the authentication process, in the event of failed matching of the received device identification information with the stored authentication-authorized device identification information. One application may allow an operation of the device for a different purpose other than the user authentication, even in the case of failed matching of the received device identification information with the stored authentication-authorized device identification information. For example, data entry from an invalid keyboard connecting with the authentication apparatus in place of a valid device provided for authentication, for example, a card reader, may be allowed for a different purpose other than the authentication process. Any operation of the device may alternatively be prohibited in the event of the failed matching.

According to another aspect, the invention is also directed to an authenticated printing system where an authenticated printing server configured to store authentication data and print data is connected in a communicable manner with a printing apparatus equipped with a device used for entry of authentication data from a user. The printing apparatus includes: a device identification information sender configured to send device identification information for identifying the device to the authenticated printing server; and an authenticated printing mechanism configured to perform an operation of receiving the print data from the authenticated printing server by the communication and a printing operation of the received print data, in response to authentication of the user based on the authentication data input from the device. The authenticated printing server includes: a device identification information storage unit configured to store authentication-authorized device identification information representing that the device is authorized to be used for authentication; and a limiter configured to, in the case of failed matching of the device identification information received from the printing apparatus with the stored authentication-authorized device identification information, restrict operation of the authenticated printing mechanism.

In the authenticated printing apparatus according to this aspect of the invention, the restricted operation of the authenticated printing mechanism may be, for example, partial or total prohibition of the data input from the device, prohibition of the matching of the device identification information, partial or total prohibition of the operation of receiving the print data from the authenticated printing server, or partial or total prohibition of the printing operation of the received print data. The restriction may be any combination of such partial and overall prohibitions. In addition to such restriction, the authenticated printing apparatus may inform a system administrator of some warning or may cause the printing apparatus to have some alarm in the form of sound, light, or vibration.

The communication in the authenticated printing system may be data transmission and reception via the network. The network may be a wired LAN, such as Ethernet (trademark), a wireless LAN, such as WiFi, a USB network, or a Bluetooth (trademark) network. The network may alternatively adopt the technique of infrared communication.

The authentication apparatus of the invention having any of the arrangements discussed above restricts the authentication process. The subject of restriction is, however, not restricted to the authentication process but may be the input of authentication data.

According to still another aspect, the invention is further directed to an authentication data input apparatus connected with a device used for data entry and configured to accept data input from the device as authentication data for authenticating a user. The authentication data input apparatus includes: a device identification information storage unit configured to store input-authorized device identification information representing that the device is authorized to input the data as the authentication data; a verifier configured to read device identification information from the device and match the read device identification information against the stored input-authorized device identification information; and a data input mechanism configured to, upon successful matching of the read device identification information with the input-authorized device identification information, allow the data input from the device as the authentication data, while in the case of failed matching of the read device identification information with the input-authorized device identification information, prohibiting the data input from the device as the authentication data.

The authentication data input apparatus according to this aspect of the invention prohibits input of the authentication data from the device in the event of replacement of a valid device provided for authentication with an invalid device, thus effectively preventing and avoiding fake authentication by device spoofing. The subject of prohibition is the input of the authentication data. The invalid device may be used for the purpose of entry of data other than the authentication data, or the operation of the invalid device may totally be prohibited.

The technique of the invention is not restricted to the authentication apparatus having any of the arrangements discussed above, the authenticated printing system, or the authentication data input apparatus but is also actualized by diversity of other applications, for example, an authentication method, an authenticated printing method, and an authentication data input method corresponding to the respective apparatuses and the system, as well as corresponding computer programs.

### BRIEF DESCRIPTION OF THE DRAWINGS

FIG. 1 schematically illustrates the configuration of an authenticated printing system 10 in a first embodiment of the invention;

FIG. 2 shows the schematic structure of a terminal PC11 included in the authenticated printing system 10 of FIG. 1;

FIG. 3 is a functional block diagram of the terminal PC11 in the embodiment;

FIG. 4 is a flowchart showing an authenticated printing routine in the first embodiment;

FIG. 5 is a flowchart showing the details of a user login process executed at step S100 in the authenticated printing routine of FIG. 4;

FIG. 6 shows one example of an operation log;

FIG. 7 is a table showing session events as objects of operation logs;

FIG. 8 shows; one example of a spooler management table for management of spooled print data;

FIG. 9 is a flowchart showing the details of a printing authentication process executed at step S300 in the authenticated printing routine of FIG. 4;

FIG. 10 shows one example of an input device identification table of identification information with regard to peripheral devices of each printer registered in an authentication server SVa1;

FIG. 11 is a flowchart showing a modified flow of input device verification executed at step S332 in the printing authentication process of FIG. 9 as one modified example;

FIG. 12 is a table showing USB class codes with their class names used in another modified example; and

FIG. 13 is a flowchart showing an input device registration process in a second embodiment of the invention.

### DESCRIPTION OF THE PREFERRED EMBODIMENTS

Some modes of carrying out the invention are described below in the following sequence as preferred embodiments with reference to the accompanied drawings.

### A. First Embodiment

A-1. Schematic Configuration of Printing System

A-2. Outline of Authenticated Printing Process

A-3. Printing Authentication Process

A-4. Modification of First Embodiment

### B. Second Embodiment

### C. Other Aspects

### A. First Embodiment

A-1. Schematic Configuration of Printing System

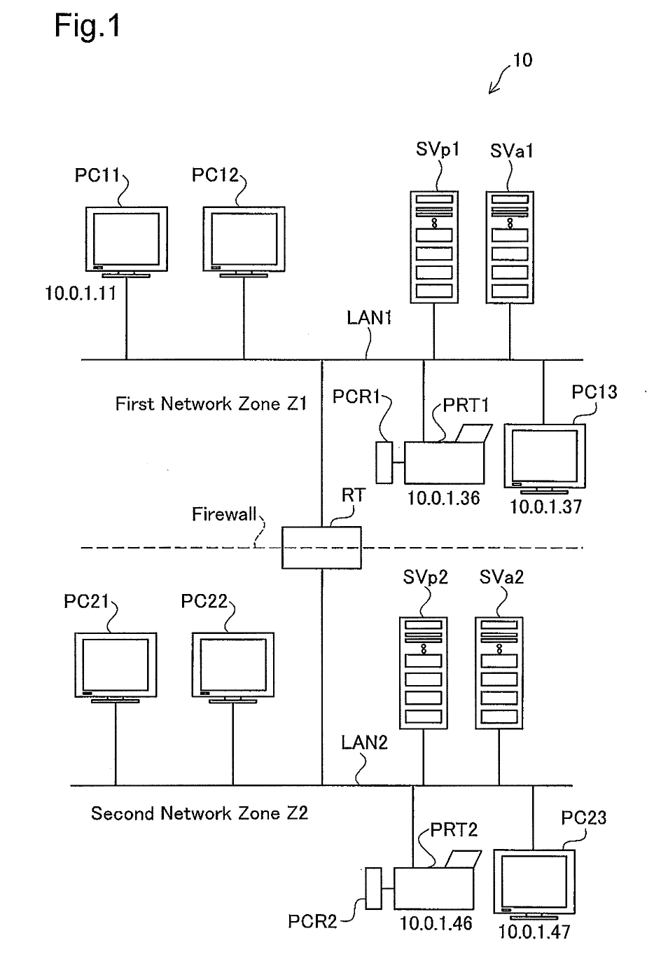

FIG. 1 schematically illustrates the configuration of an authenticated printing system 10 in a first embodiment of the invention. The authenticated printing system 10 includes a first network zone Z1 connected by means of a local area network LAN1, a second network zone Z2 connected by means of a local area network LAN2, and a router RT arranged to interconnect the two network zones Z1 and Z2 across a firewall.

In the first network zone Z1, three terminals PC11, PC12, PC13, one printer PRT1, one printer server SVp1, and one authentication server SVa1 are mutually connected by the local area network LAN1. In the second network zone Z2, three terminals PC21, PC22, and PC23, one printer PRT2, one printer server SVp2, and one authentication server SVa2 are mutually connected by the local area network LAN2. Magnetic card readers PCR1 and PCR2 for authentication are respectively connected to the printers PRT1 and PRT2.

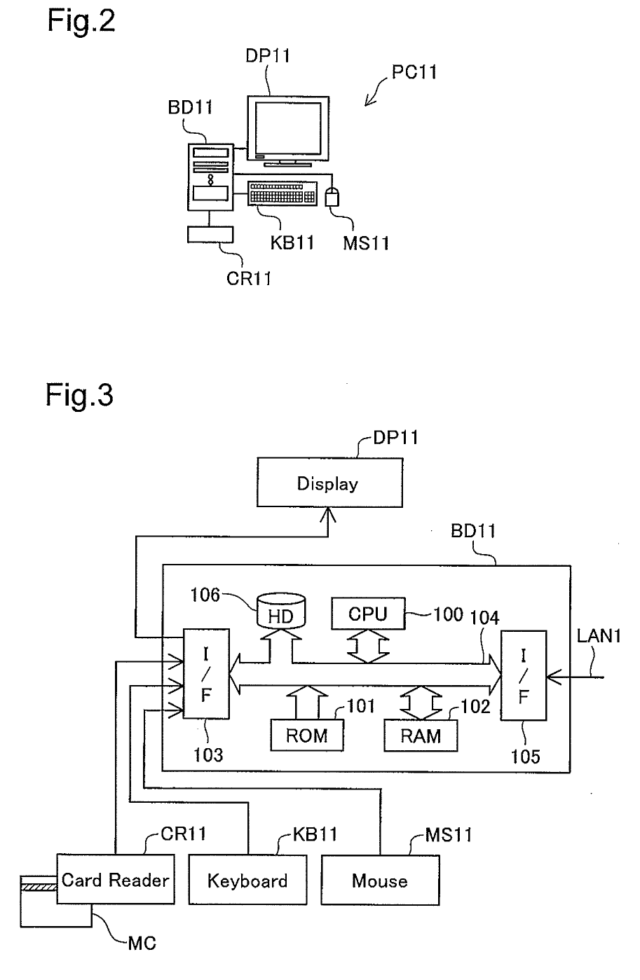

FIG. 2 shows the schematic structure of the terminal PC11 included in the authenticated printing system 10 of FIG. 1. The terminal PC11 includes a display DP11, a main body BD11, a keyboard KB11, a mouse MS11, and a card reader CR11. The other five terminal PC12, PC13, PC21, PC22, and PC23 have the same structures as that of the terminal PC11 in the embodiment.

FIG. 3 is a functional block diagram of the terminal PC11 in the embodiment. The main body BD11 has a CPU 100 configured to control the operations of the terminal PC11, as well as memories ROM 101 and RAM 102, an interface circuit (I/F) 103 for peripheral equipment, an interface circuit (I/F) 105 for network, and a hard disk (HD) 106. The CPU 100, the memories ROM 101 and RAM 102, the HD 106, and the interface circuits 103 and 105 are mutually connected by an internal bus 104. The interface circuit 103 is connected with the display DP11, the keyboard KB11, the mouse MS11, and the card reader CR11. The CPU 100 transmits data to and from the peripheral equipment via the internal bus 104 and the interface circuit 103. A cable of the local area network LAN1 is connected to the interface circuit 105 for network. Such connection enables the CPU 100 to transmit packets to and from the other terminals and the servers via the local area network LAN1. In the system of this embodiment, the respective terminals have USB connection. The function of BIOS is limited to prevent USB connection of any mass storage device. The terminal has no interface for an external storage medium, such as a flexible disk. Such limited USB connection and absence of the interface prevent the terminal from writing out data into the flexible disk or from writing out data into a memory for USB connection. This structure effectively reduces the potential of information leakage from the terminal. These terminals may be connected by an interface dedicated for a keyboard or a mouse, instead of USB connection.

A-2. Outline of Authenticated Printing Process

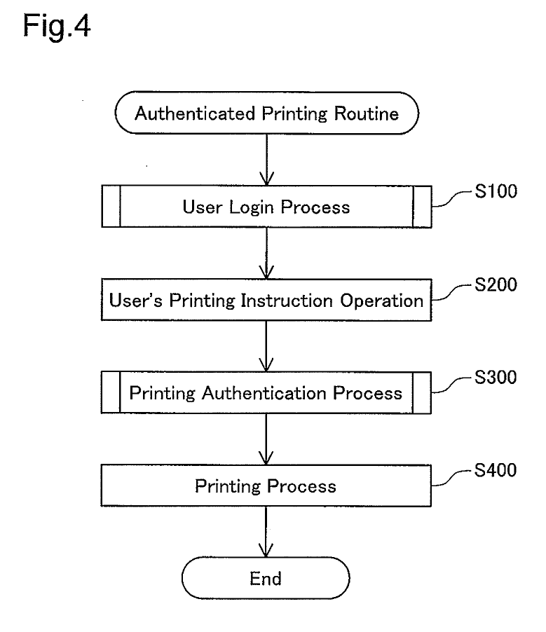

The general flow of an authenticated printing process in the authenticated printing system 10 is described below with reference to the flowchart of FIG. 4. At a start of the authenticated printing process, the user desiring a printing operation with a selected printer logs into a specific terminal (step S100). According to a concrete procedure, the user activates one of the terminals PC11 to PC13 (or the terminals PC21 to PC23) connecting with the authenticated printing system 10 and logs into the authenticated printing system 10. In the description below, it is assumed that the user activates the terminal PC11 to log into the authenticated printing system 10.

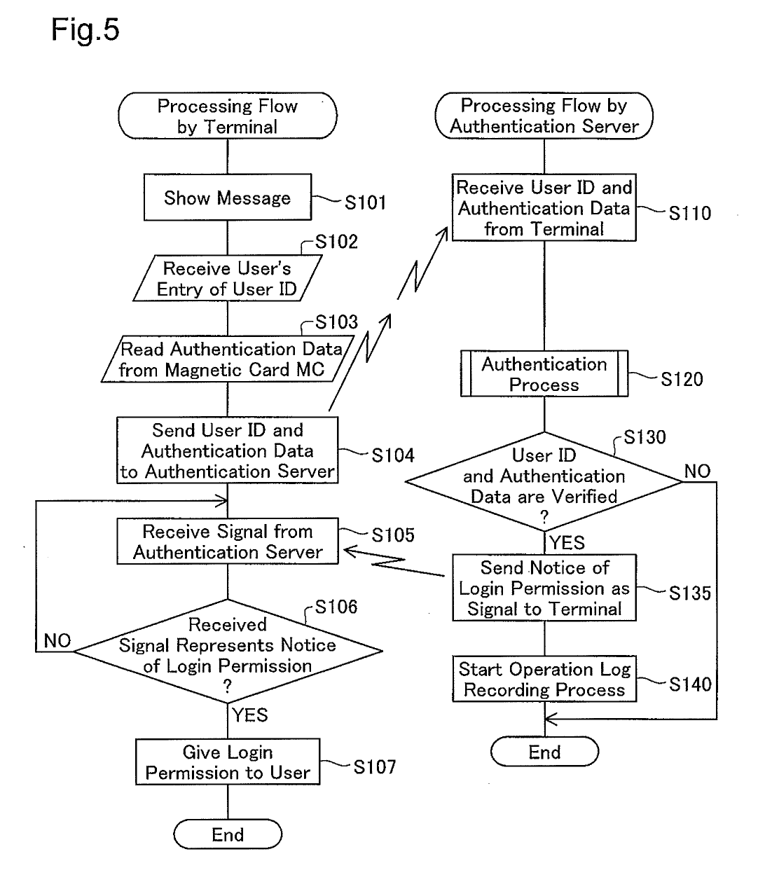

The terminal PC11 activated by the user automatically executes a pre-installed login program and starts a series of processing for system login. The details of the user login process are explained with reference to the flowchart of FIG. 5. At a start of the user login process, according to the left flow of FIG. 5, the terminal PC11 shows a preset message on the display DP11 of the terminal PC11 to ask the user to enter a user ID (user name) and swipe the user's own magnetic card MC through the magnetic card reader CR11 (step S101). In response to this message, the user operates the keyboard KB11 to enter the user ID and swipes the magnetic card MC through the card reader CR11. The terminal PC11 then inputs the user ID (step S102) and reads out authentication data recorded in advance in the swiped magnetic card MC (step S103).

The terminal PC11 sends the input user ID and the authentication data read out from the magnetic card MC to the authentication server SVa1 via the network (step S104). In this embodiment, the authentication data recorded in the magnetic card MC is used as a login password. One modification may use the data registered in the magnetic card MC as the user ID and ask the user to enter the login password through the operation of the keyboard KB11. Another method for the system login from the terminal PC11 may not use the magnetic card reader CR11 but may ask the user to directly enter both the user ID and the login password through the operation of the keyboard KB11.

In response to transmission of the user ID and the authentication data from the terminal PC11, the authentication server SVa1 executes a series of processing according to the right flow of FIG. 5. The authentication server SVa1 receives the user ID and the authentication data registered in the magnetic card MC from the terminal PC11 (step S110) and authenticates the received user ID and authentication data (step S120). The authentication server SVa1 stores in advance a table representing user IDs of the users having login permission and authentication data recorded in magnetic cards MC owned and managed by the respective users. The authentication server SVa1 checks the user ID and the authentication data received from the terminal PC11 via the network against the registered data in the table and verifies whether the user currently operating the terminal PC11 is a user having login permission to the authenticated printing system 10.

Upon successful verification of the user ID and the authentication data against the registered data (step S130), the authentication server SVa1 sends a signal representing a notice of login permission to the terminal PC11 (step S135). The terminal PC11 receives the signal from the authentication server SVa1 (step S105) and identifies whether the received signal represents the notice of login permission (step S106). Upon identification of the notice of login permission, the terminal PC11 gives a login permission and allows the user to use the terminal PC11 (step S107). The user can then freely operate the terminal PC11 with the keyboard KB11 and the mouse MS11 to browse data open to the user and to newly generate data. Unless the terminal PC11 receives the signal representing the notice of login permission from the authentication server SVa1, the terminal PC11 repeats the receiving process of step S105 and does not allow the user to freely use the terminal PC11.

After sending the signal representing the notice of login permission to the terminal PC11, the authentication server SVa1 starts an operation log recording process (step S140). The operation log recording process records the user's entries of preset operations in time series among the user's various input operations of the terminal PC11. The operation log recording process is performed by the authentication server SVa1 in this embodiment but may alternatively be performed by the terminal PC11 or a dedicated record server provided on the network.

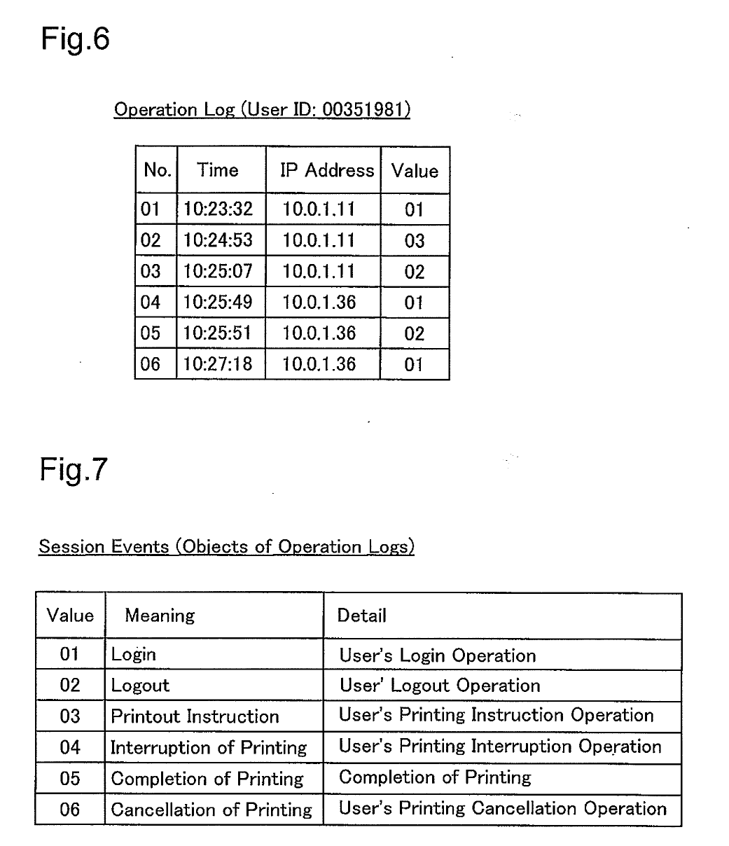

FIG. 6 is a table showing one example of an operation log in the embodiment of the invention. The operation log is recorded with regard to each user ID in the authentication server SVa1. The example of FIG. 6 shows an operation log with regard to the user having a user ID=00351981. The operation log is constructed as a database having multiple records arranged in time series and includes several items ‘time of operation’, ‘IP address of device as operation subject’, and ‘value representing operation detail’.

FIG. 7 is a table showing session events as objects of operation logs in the embodiment of the invention. The value ‘01’ as the “value representing operation detail’represents completion of a ‘login operation’. In the example of FIG. 6, a login operation to the terminal PC11 by the user having the user ID=00351981 is completed at 10:23:32. This user's login operation to the terminal PC11 starts recording the operation log. According to the operation log of FIG. 6, the user operates the terminal PC11 to give a printout instruction at 10:24:53 and logs out from the terminal PC11 at 10:25:07. In this embodiment, only the operations corresponding to the session events included in the table of FIG. 7 are recorded as the operation log. The operations other than the registered session events may be recorded as ‘other operations’.

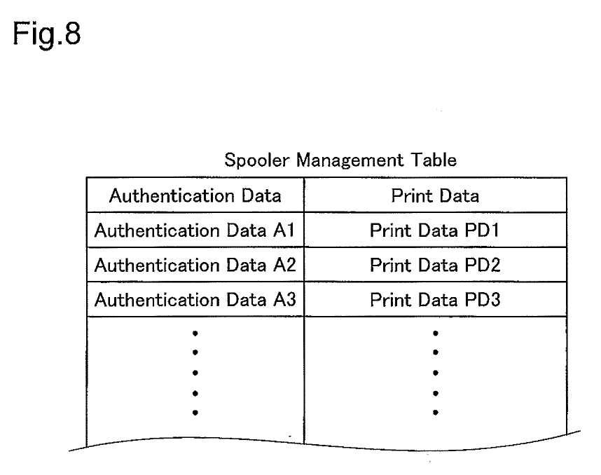

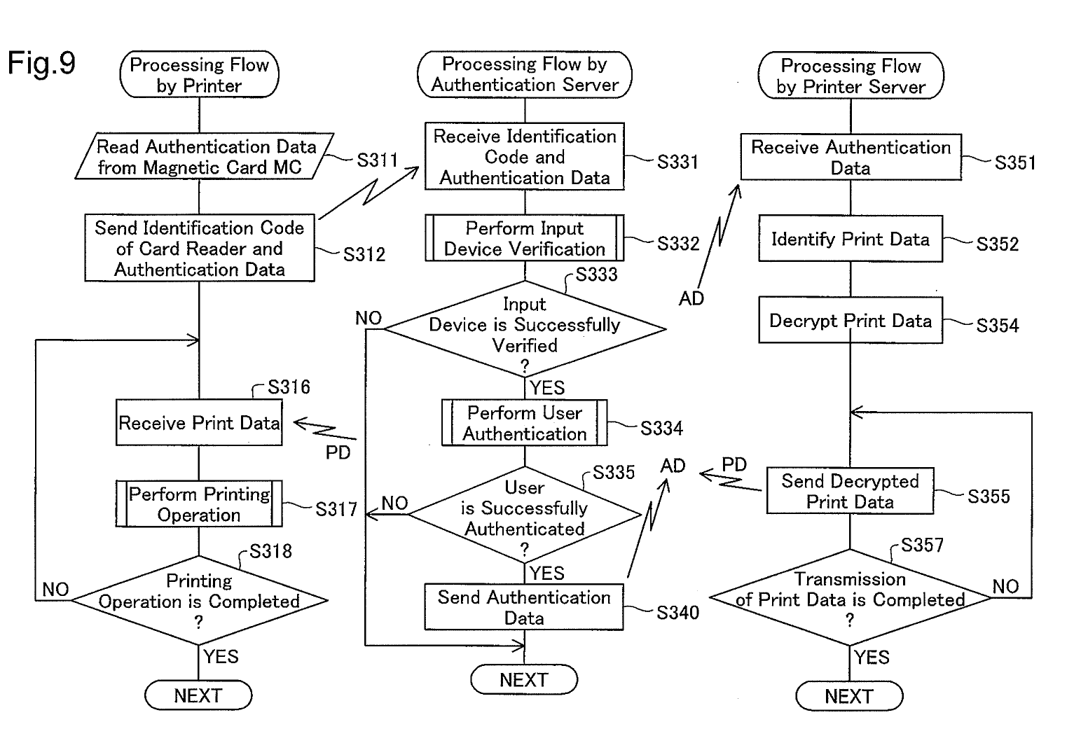

Referring back to the authenticated printing routine of FIG. 4, this completes the user login process performed by the terminal PC11 and the authentication server SVa1 (step S100). The logged-in user then operates the terminal PC11 to create or browse any documents, spreadsheets, or images and performs a printing instruction operation for printing a desired document, spreadsheet, or image (step S200). The printing instruction operation gives a printout instruction to the printer PRT1 or to the printer PRT2. This printing instruction operation is one object of the operation log recording process (see FIG. 7). In response to the user's printing instruction operation, the printer server SVp1 spools print data sent from the terminal PC11 with the authentication data for identifying the user who gives the printout instruction, in the form of a print job. A concrete spooling procedure encrypts the received print data and spools the encrypted print data in an internal hard disk of the printer server SVp1. The encrypted and spooled print data is correlated to the authentication data in the form of a spooler management table as shown in FIG. 8. The printer server SVp1 does not allow the spooled print data to be output to the printer PRT1 or PRT2 until completion of a printing authentication process discussed later. Namely a printout is not immediately output from the printer PRT1 or PRT2 in response to the user's printout instruction given through the operation of the terminal PC11. On completion of the printing instruction operation, the user logs out from the terminal PC11 and moves to the selected printer PRT1 or PRT2. The logout operation is also one object of the operation log recording process as shown in FIG. 7 and is thus recorded as a session event.

In response to the user's logout from the terminal PC11, the authentication server SVa1 may send the record of the operation log to the logout in the form of log information to the authentication server SVa2 and the respective terminals PC11 to PC13 and PC21 to PC23 and the printers PRT1 and PRT2, in addition to storage of the log information in the authentication server SVa1. Sending the log information of a certain user to another server and the respective terminals and printers allows local authentication of the certain user operating another terminal to log into the authenticated printing system.

Referring back to the authenticated printing routine of FIG. 4, the user logged out from the terminal PC11 carries the magnetic card MC and moves to the printer PRT1 or PRT2 selected for printing to perform a printing authentication process (step S300). The printing authentication process allows a printing operation only after successful authentication by the printer and is preferably applied, for example, in the case of printing classified documents and in the case of sharing a high-performance printing apparatus by multiple users. When a printer is located away from a terminal currently operated by the user to give a printout instruction, there is a risk that a printout of a classified document may be leaked to a third person before the user reaches the location of the printer. In order to prevent such potential leakage, the printing authentication process performs authentication by the printer and starts an actual printing operation. The details of the printing authentication process will be discussed later. The user operates the printer PRT1, for example, to perform the printing authentication process with the magnetic card MC. Upon successful authentication of the user by the printer PRT1, the printer PRT1 performs an actual printing operation (step S400). At this moment, the printer server SVp 1 decrypts the print data, which is encrypted and spooled in the printer server SVp1 in response to the user's printout instruction from the terminal PC11. The decrypted print data is sent to the printer PRT1 via the local area network LAN1 to be printed. The decryption may be performed by the printer PRT1, instead of the printer server SVp1.

A-3. Printing Authentication Process

FIG. 9 is a flowchart showing the details of the printing authentication process executed at step S300 in the authenticated printing routine of FIG. 4. The printing authentication process includes three cooperative processing flows respectively performed by the printer PRT1, the authentication server SVa1, and the printer server SVp1. The left flow shows a series of printing process (steps S311 to S318) performed by the printer PRT1 equipped with the magnetic card reader PCR1. The middle flows shows a series of authentication process (steps S331 to S340) performed by the authentication server SVa1 in response to an authentication request from the printer PRT1. The right flow shows a series of print data transmission process (steps S351 to S357) performed by the printer server SVp1 to decrypt and output print data, which is encrypted and spooled in the printer server SVp1 in response to the user's printout instruction, to the printer PRT1. The details of the three cooperative processing flows in the printing authentication process are discussed with reference to the flowchart of FIG. 9.

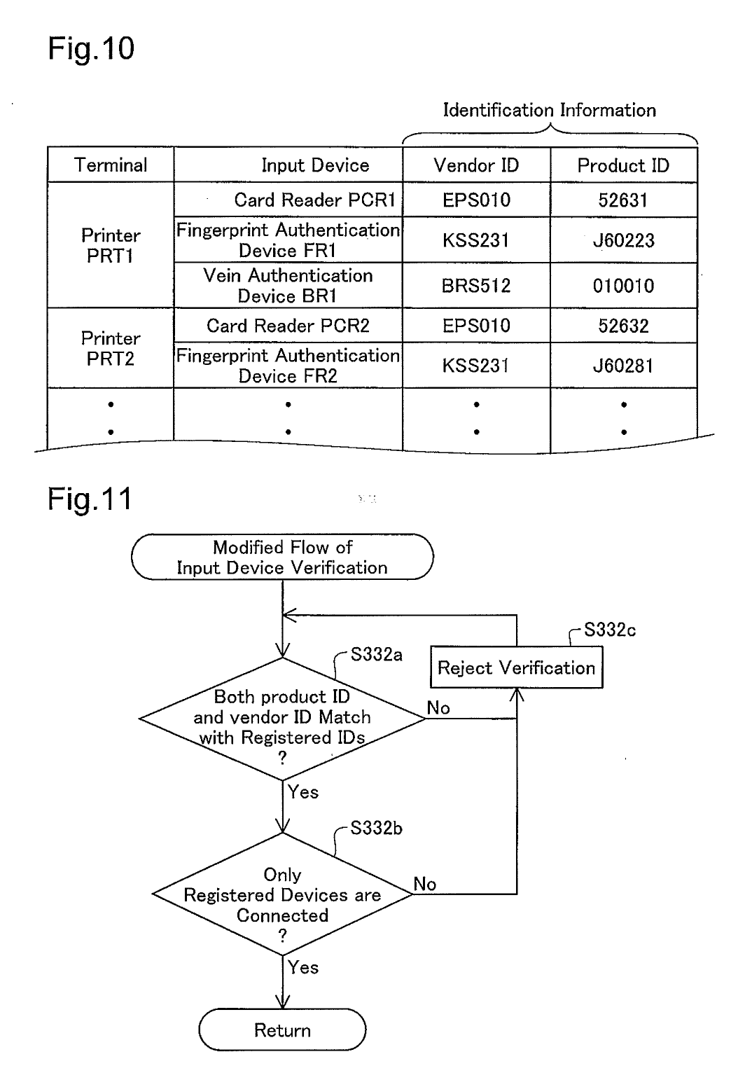

The user giving a printout instruction through the operation of the terminal PC11 swipes the magnetic card MC through the magnetic card reader PCR1 of the printer PRT1 to obtain a printout from the printer PRT1. The printer PRT1 reads out the registered authentication data from the magnetic card MC (step S311) and sends the authentication data read from the magnetic card MC and an identification code as identification information of the magnetic card reader PCR1 to the authentication server SVa1 (step S312). The identification code as the identification information of the magnetic card reader PCR1 includes a vendor ID representing the manufacturer of the magnetic card reader PCR1 and a product ID representing a product number allocated to the magnetic card reader PCR1 as a product as shown in FIG. 10. The vendor ID is a code uniquely allocated to each manufacturer of certain products, for example, magnetic card readers, and the product ID is a code uniquely allocated to each of the certain products supplied by the manufacturer. The identification information given as a combination of the vendor ID and the product ID is accordingly a unique code for identifying each product.

The printer PRT1 sends a packet including the identification code and the authentication data read from the magnetic card MC with a header representing the address of the authentication server SVa1 as the receiver to the local area network LAN1. The authentication server SVa1 recognizes itself as the destination of the packet including the identification code based on the header and receives the identification code and the authentication data (step S331). The authentication server SVa1 subsequently performs input device verification to check the received identification code against previously-registered identification codes and accordingly verifies whether the magnetic card reader PCR1 connected to the printer PRT1 is a valid input device (step S332). As shown in FIG. 10, the authentication server SVa1 registers in advance a table of identification codes allocated to peripheral devices attached to each of the printers connecting with the local area network LAN1, for example, the printers PRT1 and PRT2. The authentication server SVa1 refers to this table and checks the validity of the combination of the received identification code with the printer as the sender of the identification code. The system administrator manually registers the table in the authentication server SVa1 in this embodiment. The system administrator with the administrative privileges logs in the authentication server SVa1 to directly edit the input device identification table shown in FIG. 10. In the case of attachment of a new input device to the printer, the system administrator previously adds a vendor ID and a product ID of the new input device to the table registered in the authentication server SVa1.

The identification code is given as the combination of the vendor ID and the product ID in this embodiment. A code representing the type of each input device may additionally be correlated to this identification code. In the illustrated example of FIG. 10, the code representing the type of each input device attached to each printer is correlated to the vendor ID and the product ID. In the case of replacement of an input device for obtaining authentication data as one peripheral device of a certain printer, the authentication server SVa1 immediately responds to such replacement as long as the input device is registered in advance. One modified procedure of the input device verification does not check the identification code as the combination of the vendor ID and the product ID but rejects the verification when the printer sends authentication data read from any non-registered input device.

Upon successful input device verification that the received identification code matches with a registered identification code allocated to one of the peripheral devices attached to the printer PRT1 as the sender of the identification code (step S333), the authentication server SVa1 analyzes the received authentication data and performs user authentication to check the authentication data against registered authentication data of the users (step S334). Upon successful user authentication that the received authentication data matches with registered authentication data regarding one of the users (step S335), the authentication server SVa1 determines the successful authentication of both the magnetic card reader PCR1 as the input device and the user and outputs authentication data AD to the printer server SVp1 (step S340). In the event of failed input device verification that the received identification information does not match with any registered identification information of the peripheral devices attached to the printer PRT1 (step S333) or in the event of failed user authentication that the received authentication data does not match with any registered authentication data of the users (step S335), the authentication server SVa1 immediately terminates the processing flow of the printing authentication process. In this case, no authentication data is sent from the authentication server SVa1 to the printer server SVp1. A predetermined abnormal time operation may be performed in the event of such failed authentication. The abnormal time operation may interrupt or stop the respective processing flows performed by the printers and the servers or may inform the user of the occurrence of some abnormality, for example, by an alarm sound or an alarm message.

Upon successful authentication, the authentication server SVa1 sends a packet including the authentication data AD with a header representing the address of the printer server SVp1 as the receiver to the local area network LAN1 (step S340). The printer server SVp1 recognizes itself as the destination of the packet including the authentication data AD based on the header and receives the authentication data AD (step S351). The printer server SVp1 subsequently identifies print data correlated to the received authentication data in the internal hard disk (step S352). As discussed previously with reference to FIG. 8, the printer server SVp1 spools the encrypted print data in correlation to the authentication data. The printer server SVp1 accordingly retrieves the encrypted and spooled print data based on the received authentication data and decrypts the retrieved print data (step S354). The printer server SVp1 sends the decrypted print data PD to the printer PRT1 (step S355).

The decrypted print data PD sent to the local area network LAN1 is divided into multiple packets with a header representing the address of the printer PRT1 as the receiver. The printer PRT1 successively receives the multiple packets of the decrypted print data PD from the local area network LAN1 (step S316), reconstructs the received multiple packets into image data, and performs an actual printing operation of the reconstructed image data (step S317). This series of processing of decrypting and sending the print data, receiving the decrypted print data, and printing the received print data is repeated until completion of transmission and printing of all the print data (steps S318 and S357). On completion of such decryption, transmission, reception, and printing of all the print data, the printer PRT1 completes the printing operation and returns to standby. The printer server SVp 1 also returns to the initial state.

As described above, the authenticated printing system 10 of the first embodiment verifies whether the magnetic card reader PCR1 connected to the printer PRT1 is a valid input device in the printing authentication process executed at step S300 in the authenticated printing routine of FIG. 4. Even when an identity thief without the legitimate magnetic card MC replaces the valid magnetic card reader PCR1 connected to the printer PRT1 with an invalid magnetic card reader to impersonate a legitimate user and sends fake authentication data to the authentication server Sval, the printing authentication process desirably prevents the authentication server SVa1 from authenticating the received fake authentication data as legitimate authentication data. This arrangement desirably prevents the identity thief replacing the valid magnetic card reader PCR1 from spoofing as the legitimate user and accordingly prevents any classified document or any other printout from being illegally obtained from the printer PRT1.

Input devices used as peripheral devices of printers are generally connected by a general-purpose bus, such as USB, from the viewpoint of product standardization. When authentication data sent from an input device is a character string, it is conventionally impossible to identify the input device as a card reader or a keyboard. The printing authentication process of the first embodiment, however, effectively detects the identity thief's unauthorized operation of replacing a keyboard with the magnetic card reader PCR1 and operating the keyboard to enter a code magnetically recorded in the magnetic card MC and prevents the print data from being illegally sent to the printer PRT1. In the authenticated printing system 10 including the terminals, the servers, and the printers interconnected via the network, this arrangement ensures the high security even when an input device used for authentication (for example, the magnetic card reader PCR1) is connected by the general-purpose bus.

A-4. Modification of First Embodiment

The input device verification of the first embodiment checks the received identification code as the combination of the vendor ID and the product ID against a previously registered identification code and verifies whether the input device connected to the printer is a valid input device. One modified procedure of the input device verification may additionally determine whether only registered devices are connected to the printer. FIG. 11 is a flowchart showing one modified flow of input device verification executed by the authentication server SVa1 at step S332 in the printing authentication process of FIG. 9.

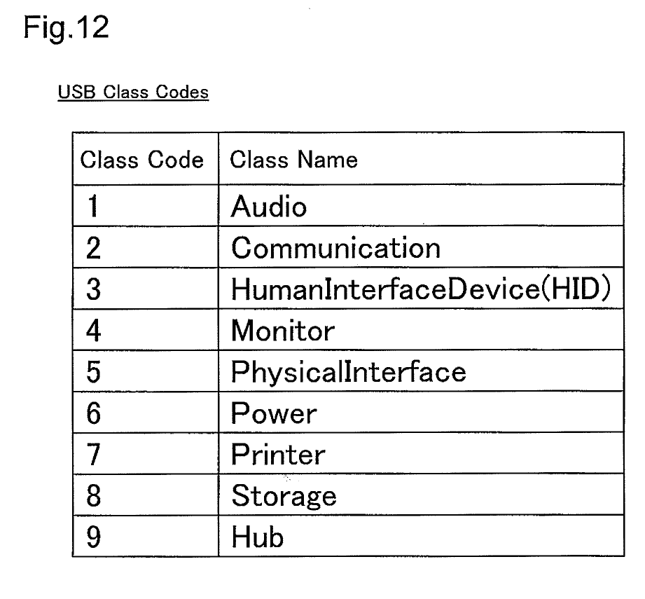

The modified flow of input device verification shown in FIG. 11 determines whether only input devices registered in advance as connectable devices are connected to the printer (step S332b), in addition to the determination of whether both the vendor ID and the product ID match with the previously registered IDs (step S332a) as described in the first embodiment. When any unregistered input device, for example, a keyboard, other than the magnetic card reader PCR1, a fingerprint authentication device FR1, and a vein authentication device BRI shown in FIG. 10 is connected to the printer PRT1, this modified flow of input device verification rejects the verification (step S332c). In the general-purpose bus, such as USB, an inquiry may be made about a class code of each input device connected to the printer. FIG. 12 shows class codes defined in the USB standard. The class code may be used in place of the identification code of each input device. The determination of whether any device other than the input devices registered in advance is connected to the printer PRT1 may be based on this class code.

### B. Second Embodiment

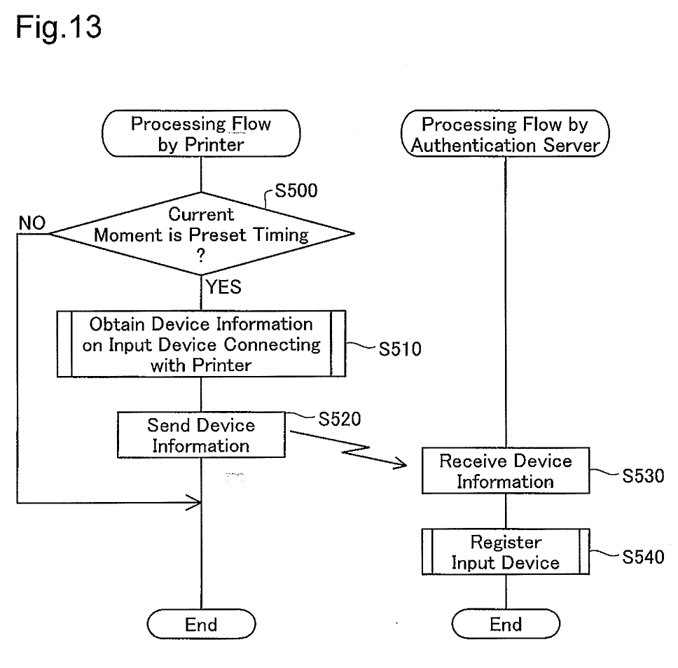

An authenticated printing system in a second embodiment of the invention is discussed below. The authenticated printing system of the second embodiment has the system configuration (see FIGS. 1 through 3) and the fundamental processing (see FIGS. 4 through 10) similar to those of the authenticated printing system 10 of the first embodiment discussed above. The primary difference of the second embodiment from the first embodiment is the procedure of creating an input device identification table as shown in FIG. 10. In the authenticated printing system 10 of the first embodiment, the system administrator manually registers the identification codes in the form of the input device identification table shown in FIG. 10. The authenticated printing system of the second embodiment, on the other hand, automatically registers input devices. FIG. 13 is a flowchart showing an input device registration process in the second embodiment.

The printer performs the input device registration process immediately after power activation. In response to the user's power-on operation, the printer performs a predetermined initialization operation and determines whether the current moment is a preset timing (step S500). The preset timing is registered in advance in the printer and is, for example, the user's long press of a specified operation button at the time of power supply. The preset timing is not restricted to the timing immediately after the power activation but may be an unusual combination of operations of selected buttons, for example, the user's simultaneous long press of Reset button and Print button.

Upon determination that the current moment is the preset timing, the printer obtains device information on each input device currently connecting with the printer (step S510). The printer communicates with each input device connecting with the printer and obtains device information on the input device, for example, an identification code including a vendor ID and a product ID. The printer sends the obtained device information, for example, with a header representing the address of the authentication server SVa1 to the network (step S520).

The authentication server SVa1 monitors data flowing on the network to find information (packet) addressed to the authentication server SVa1, for example, based on the header, and receives the addressed information (step S530). The authentication server SVa1 then analyzes the received information and, when the received information includes the identification code of the input device connecting with the printer, registers the identification code in the input device identification table as shown in FIG. 10 (step S540). The input device connecting with the printer is thus automatically registered in the authentication server SVa1.

The authenticated printing system of the second embodiment does not require the system administrator to manually register the respective devices connecting with each printer and thus advantageously facilitates the management of the respective input devices for authentication connecting with the printer. One modification may automatically register the input devices according to the procedure of the second embodiment and allow the system administrator to manually edit the input device identification table according to the requirements. The second embodiment describes registration of only the input devices connecting with the printer. The similar procedure may be adopted to automatically register input devices connecting with each of the terminals PC11 through PC13 and PC21 through PC23 into the authentication server SVa1.

### C. Other Aspects

The embodiments discussed above are to be considered in all aspects as illustrative and not restrictive. There may be many modifications, changes, and alterations without departing from the scope or spirit of the main characteristics of the present invention. Some examples of possible modification are given below. C-1. Modification 1

In the authenticated printing systems of the above embodiments, the printer or the authentication server constructed as the authentication apparatus for performing authentication verifies whether each input device connecting with the printer is a valid input device. The technique of the invention may also be actualized by an authentication data input apparatus. In this application, the authentication data input apparatus checks an identification code of each connected input device, and upon failed verification of the input device as any previously registered device, does not accept entry of authentication data. The authentication data input apparatus may otherwise add specific unavailability data to input data to make the input data unavailable as authentication data. The authentication data input apparatus may not treat the input data with the specific unavailability data as the authentication data, while otherwise accepting entry of the input data as the authentication data.

C-2. Modification 2

In the authenticated printing systems of the above embodiments, the terminal PC11 is equipped with the HD 106. Namely the authenticated printing system is constructed as an ordinary server client system including multiple rich clients. Each of multiple terminals may alternatively be constructed as a thin client terminal without a nonvolatile storage medium, such as a hard disk or a flash memory, and the whole authenticated printing system may be constructed as a thin client system. In the thin client system, each thin client terminal has only the restricted functions, that is, the function of connecting with the local area network LAN1 and the user interface function, and causes the server to perform required series of data processing. In the thin client system, the programs to be executed by the respective terminals are managed on the network. This thin client configuration enhances the security of the authenticated printing system. In the thin client system, all the thin client terminals are regarded equivalently but are distinguished by address information, such as a MAC address of each communication device or an IP address allocated to each terminal.

In the thin client system, each thin client terminal does not allow direct data input or output. Disabling the hardware connection for data input and output advantageously protects the thin client terminals from virus infection and leakage of classified information. The system administrator is required to manage only the servers. Another advantage of the thin client system is thus significant reduction of management load of the system administrator.

C-3. Modification 3

In the authenticated printing systems of the above embodiments, the authentication server performs the authentication and controls the printing operation, while the printer server spools the print data. The authentication server and the printer server may be constructed to individually have both the authentication and printing control functions and the print data spooling function. Each printer or terminal may be constructed to have the print data spooling function.

C-4. Modification 4

The authenticated printing systems of the above embodiments prohibit authentication and subsequent printing in the case where the identification information of an input device connecting with the printer does not match with any registered identification information. One modification may restrict the authentication and the subsequent printing, instead of such prohibition. In one example of restricted authentication, when the identification code of an input device connecting with the printer does not match with any registered identification codes, the authenticated printing system may ask the user to enter a password via a printer interface and accept authentication in response to the user's entry of a valid password. In another example of the restricted authentication, the authenticated printing system may communicate with the system administrator and accept authentication upon the verification by the system administrator or a supervisor of the user. In one example of the restricted printing, the authenticated printing system may add a watermark of ‘illegal printing by invalid device’ to the print face of each sheet. In another example of the restricted printing, the authenticated printing system may allow printing only in the unit of one page. In still another example of the restricted printing, the authenticated printing system may cause the printer to give a warning voice message of ‘illegal printing by invalid device’ while allowing printing.

All changes within the meaning and range of equivalency of the claims are intended to be embraced therein. The scope and spirit of the present invention are indicated by the appended claims, rather than by the foregoing description.

What is claimed is:

1. An authentication apparatus configured to authenticate a user, the authentication apparatus comprising:
a device used for data entry;
an authentication processor configured to input authentication data from the device and perform an authentication process;
a device identification information receiver configured to receive device identification information for identifying the device from the device;
a device identification information storage unit configured to store authentication-authorized device identification information representing that the device is authorized to be used for authentication; and
a limiter configured to restrict the authentication process, in the case of failed matching of the received device identification information with the stored authentication-authorized device identification information.

2. The authentication apparatus in accordance with claim 1, wherein the device identification information storage unit has a register configured to receive device identification information of a device connecting with the authentication apparatus at a predetermined timing and store the received device identification information as the authentication-authorized device identification information.

3. The authentication apparatus in accordance with claim 1, the authentication apparatus further having:
a setter configured to store specific device identification information of a preset device as the authentication-authorized device identification information into the device identification information storage unit.

4. The authentication apparatus in accordance with claim 1, wherein the limiter imposes a restriction of prohibiting at least one of the data input from the device and the authentication process.

5. The authentication apparatus in accordance with claim 1, wherein the device identification information is a unique code of uniquely identifying the device.

6. The authentication apparatus in accordance with claim 5, wherein the unique code includes a vendor code of identifying a manufacturer of the device and a product code allocated to the device.

7. The authentication apparatus in accordance with claim 1, wherein the device is connectable by a general-purpose bus provided for the authentication apparatus and stores class information representing a class defined on the general-purpose bus as the device identification information.

8. The authentication apparatus in accordance with claim 1, the authentication apparatus being built in a printing apparatus connecting with a network,
wherein the printing apparatus is configured to obtain print data from a server connected with the printing apparatus via the network and performs a printing operation of the print data, in response to authentication of the user by the authentication apparatus.

9. An authenticated printing system where an authenticated printing server configured to store authentication data and print data is connected in a communicable manner with a printing apparatus equipped with a device used for entry of authentication data from a user,
the printing apparatus comprising:
a device identification information sender configured to send device identification information for identifying the device to the authenticated printing server; and
an authenticated printing mechanism configured to perform an operation of receiving the print data from the authenticated printing server by the communication and a printing operation of the received print data, in response to authentication of the user based on the authentication data input from the device,
the authenticated printing server comprising:
a device identification information storage unit configured to store authentication-authorized device identification information representing that the device is authorized to be used for authentication; and
a limiter configured to restrict operation of the authenticated printing mechanism, in the case of failed matching of the device identification information received from the printing apparatus with the stored authentication-authorized device identification information.

10. The authenticated printing system in accordance with claim 9, wherein the limiter imposes a restriction of prohibiting at least one of the data input from the device, the matching of the device identification information, the operation of receiving the print data from the authenticated printing server, and the printing operation of the received print data.

11. The authenticated printing system in accordance with claim 9, wherein the communication is data transmission and reception via the network.

12. The authenticated printing system in accordance with claim 10, wherein the communication is data transmission and reception via the network.

13. An authentication method of authenticating a user, the authentication method comprising:
storing in advance authentication-authorized device identification information representing that a device used for entry of authentication data is authorized to be used for authentication;
receiving device identification information for identifying the device from the device; and
upon successful matching of the received device identification information with the stored authentication-authorized device identification information, allowing input of the authentication data from the device and performing an authentication process of authenticating the user based on the input authentication data, while in the event of failed matching of the received device identification information with the stored authentication-authorized device identification information, restricting the authentication process.
